(19) United States
(12) Patent Application Publication
(10) Pub. No.: US 2009/0300849 A1
(43) Pub. Date: Dec. 10, 2009

(54) METHOD OF EXTRACTING OIL OF CLOTH VIA SUPERCRITICAL FLUID

(76) Inventors: Po-Jen Cheng, Shulin City (TW); Li-Hao Cheng, Shulin City (TW); Chih-Huang Cheng, Shulin City (TW)

Correspondence Address: The Weintraub Group, P.L.C., 28580 Orchard Lake Road, Suite 140, Farmington Hills, MI, 48334, US

(21) Appl. No.: 12/430,317

(22) Filed: Apr. 27, 2009

(30) Foreign Application Priority Data
Jun. 5, 2008 (TW) 097120900

(51) Int. Cl. B01D 11/02; D06L 1/02

(52) U.S. Cl. 8/142

(57) ABSTRACT

The present invention relates to a method of extracting oil of cloth via supercritical fluid, comprises the steps of: a cloth to be extracted is provided in an extracting tank; a gas is filled into a storing tank; a water-cooling machine is provided and served to cool down the temperature of the gas; a pump is provided and served to compress the gas; a water-heating machine is provided and served to raise the temperature of the gas so the gas becomes a supercritical fluid; and the supercritical fluid is inserted into the extracting tank for extracting the oil. By the above mentioned method, the cleanness of the cleanroom wiping cloth can be immediately sensed and obtained, and the gas can be recycled for achieving energy-saving.

### FIELD OF THE INVENTION

The present invention relates to a method of extracting oil of cloth, more particularly to a method of extracting oil of cloth via supercritical fluid.

### DESCRIPTION OF RELATED ART

A conventional cleaning method for a cloth, e.g. a cleanroom wiping cloth, is using surfactants and massive amount of water, such method would not only waste water resource but also the production cost is raised due to pollution generated from the processing procedures and discharging of the surfactants.

A conventional cleaning method for a cleanroom wiping cloth is has plural procedures such as rising and drying (ironing), such method would also raise the production cost and shall be improved.

### SUMMARY OF THE INVENTION

One object of the present invention is to provide a method of extracting oil of cloth via supercritical fluid, the supercritical fluid (SCF) is served to clean a cleanroom wiping cloth, so there is no need of surfactants and water, thus production cost can be saved and environmental pollution can be avoided.

One another object of the present invention is to provide a method of extracting oil of cloth via supercritical fluid, the supercritical fluid (SCF) is served to clean a cleanroom wiping cloth; the parameters, e.g. the pressure, the temperature, the flowing rate, the time, of the supercritical fluid are controlled for cleaning and there is no need of drying (ironing) process so production cost can be saved.

One another object of the present invention is to provide a method of extracting oil of cloth via supercritical fluid, the supercritical fluid (SCF) is served to clean a cleanroom wiping cloth; the supercritical fluid can be recycled thus production cost can be saved and environmental pollution can be avoided.

One another object of the present invention is to provide a method of extracting oil of cloth via supercritical fluid, an ultraviolet sensor is provided and served to sense the concentration of the oil, so the amount of oil containing in the cloth after being extracted is immediately obtained.

For achieving the objects mentioned above, the present invention provides a method of extracting oil of cloth via supercritical fluid, comprises the steps of: a cloth to be extracted is provided in an extracting tank; a gas is filled into a storing tank; a water-cooling machine is provided and served to cool down the temperature of the gas; a pump is provided and served to compress the gas; a water-heating machine is provided and served to raise the temperature of the gas so the gas becomes a supercritical fluid; and the supercritical fluid is inserted into the extracting tank for extracting the oil.

### BRIEF DESCRIPTION OF THE DRAWINGS

FIG. 1 is a schematic flowchart of a method of extracting oil of cloth via supercritical fluid of one preferred embodiment of the present invention;

FIG. 2 is a schematic view of equipments used in the method of extracting oil of cloth via supercritical fluid of one preferred embodiment of the present invention;

FIG. 3a is schematic view illustrating that the extracted cloth which is in a whole bolt status can be reeled on the outer end of the slot holes;

FIG. 3b is schematic view illustrating that the extracted cloth which is in a scattering-pieces status can be provided on the outer end of the slot holes.

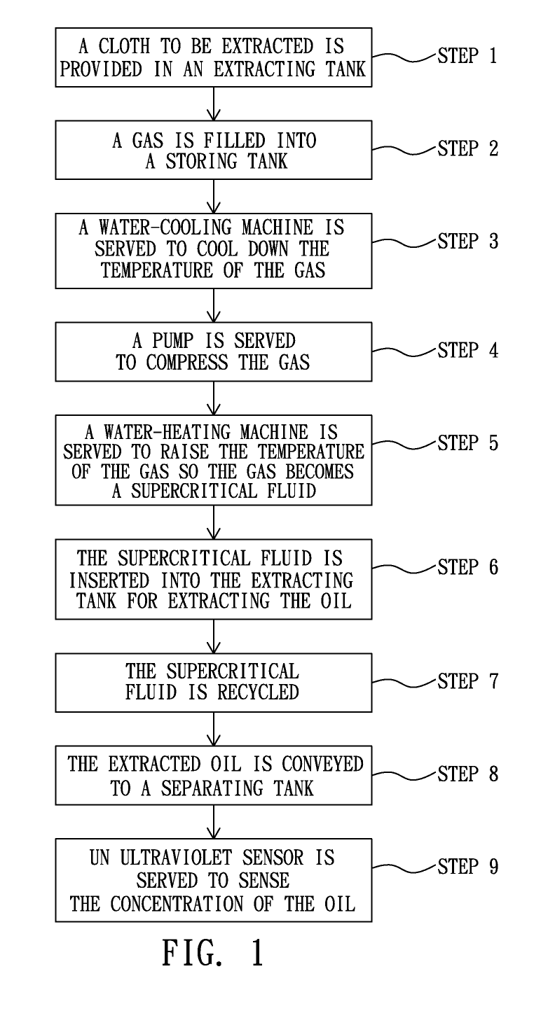

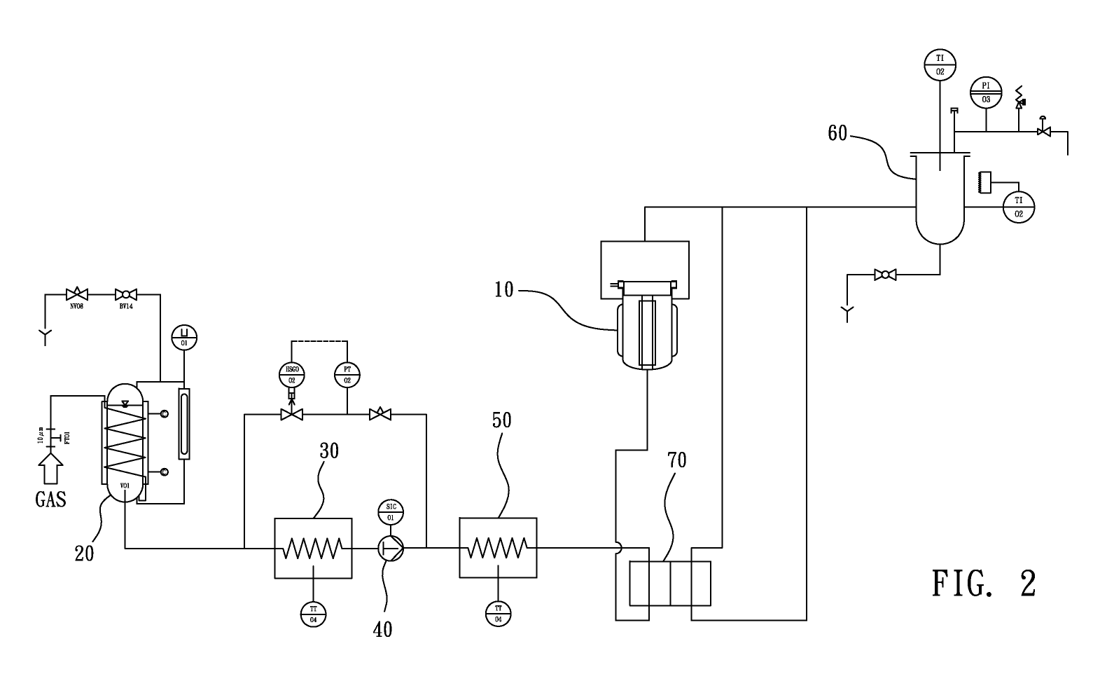

### DETAILED DESCRIPTION OF THE PREFERRED EMBODIMENT

As shown in figures, the method of extracting oil of cloth via supercritical fluid provided by the present invention comprises the steps of: a cloth to be extracted is provided in an extracting tank 10 (Step 1); a gas is filled into a storing tank 20 (Step 2); a water-cooling machine 30 is provided and served cool down the temperature of the gas (Step 3); a pump 40 is provided and served to compress the gas (Step 4); a water-heating machine 50 is provided and served to raise the temperature of the gas so the gas becomes a supercritical fluid (Step 5); and the supercritical fluid is inserted into the extracting tank 10 for extracting the oil (Step 6).

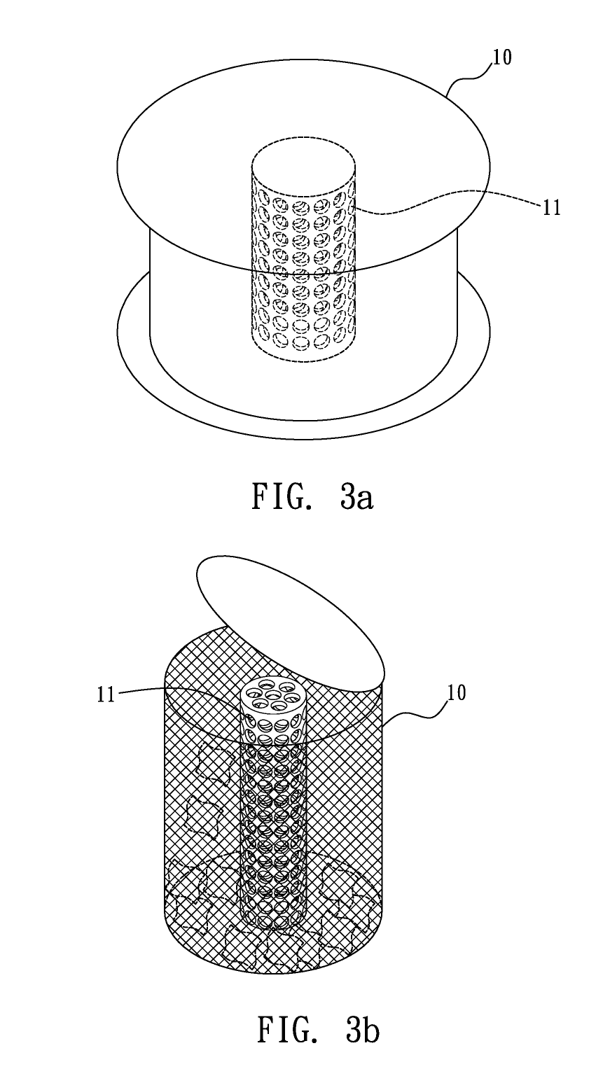

In the Step 1, the cloth to be extracted is provided in the extracting tank 10; wherein the cloth is a, e.g. but not limited to, a cleanroom wiper, a cleanroom wiping cloth or an aseptic cloth, and a cleanroom wiping cloth is served for illustration in this embodiment; the central portion of the extracting tank 10 is provided with plural slot holes 11 for letting the gas being filled into, and the extracted cloth which is in a whole bolt status can be reeled at the outer end of the slot holes 11 (as shown in FIG. 3a) or the extracted cloth which is in a scattering-pieces status can be provided at the outer end of the slot holes 11 (as shown in FIG. 3b).

In the Step 2, the gas in filled into the storing tank 20; wherein the gas is a supercritical fluid (SCF), e.g. but not limited to, a carbon dioxide, and the carbon dioxide can be further provided with agents such as MeOH, ETOH, IPA or Acetone but the concentration of the agents is ˜10%.

In the Step 3, the water-cooling machine 30 is provided and served cool down the temperature of the gas; wherein coiled pipes (not shown) made of carbon dioxide are provided in the water tank of the water-cooling machine 30 for condensing the gas, so the gas is ensured to be the over-liquefied gas before entering the entrance of the pump 40.

In the Step 4, the pump 40 is served to compress the gas; wherein the pump 40 is, e.g. but not limited, a diaphragm pump for conveying and compressing the liquefied gas.

In the Step 5, the water-heating machine 50 is provided and served to raise the temperature of the gas so the gas becomes a supercritical fluid which is in a status difference from solid, liquid or gas, and is defined as a forth status; wherein coiled gas pipes (not shown) are provided in the water tank of the water-heating machine 50, so according to the actual needs the gas can be pressurized for raising the temperature thereof, e.g. but not limited to, 10˜150° C., the pressure is, but not limited to, 10˜1000 bar.

In the Step 6, the supercritical fluid is inserted into the extracting tank 10 for extracting the oil; wherein the high-temperature supercritical fluid is inserted into the extracting tank 10 via the plural slot holes 11 for process the operation of extracting the oil in the cloth.

The method of extracting oil of cloth via supercritical fluid provided by the present invention further includes a step of recycling the supercritical fluid (Step 7), after the supercritical fluid in the extracting tank 10 is extracted, the extracted supercritical fluid can be recycled to the inlet where the gas in filled, so the production cost is lowered and the environmental pollution is avoided.

The method of extracting oil of cloth via supercritical fluid provided by the present invention further includes a step of conveying the extracted oil to a separating tank 60 (Step 8), the oil extracted in the extracting tank 10 is conveyed to the separating tank 60 for being recycled and reutilized, so the production cost is lowered and the environmental pollution is avoided.

The method of extracting oil of cloth via supercritical fluid provided by the present invention further includes a step of sensing the concentration of the oil via an ultraviolet (UV) sensor 70 (Step 9); wherein the UV sensor 70 is provided outside of the extracting tank 10 for obtaining the amount of oil containing in the cloth after being extracted, the wavelength of the UV sensor 70 is, but not limited to, 254 nm or is a variable wavelength between 190˜700 nm.

Comparing to the conventional cleaning methods, the method of extracting oil of cloth via supercritical fluid provided by the present invention has following advantages: 1. the supercritical fluid is served to clean a cleanroom wiping cloth, so there is no need of surfactants and water so the production cost is lowered and the environmental pollution is avoided; 2. the parameters, e.g. the pressure, the temperature, the flowing rate, the time, of the supercritical fluid are controlled for cleaning and there is no need of drying (ironing) process thus the production cost is saved; 3. the supercritical fluid is served to clean a cleanroom wiping cloth so the supercritical fluid can be recycled, the production cost is therefore lowered and the environmental pollution is avoided; and 4. an ultraviolet sensor is served to sense the concentration of the oil, so the amount of oil containing in the cloth after being extracted is immediately obtained.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of extracting oil of cloth via supercritical fluid, comprises the steps of:
a cloth to be extracted is provided in an extracting tank;
a gas is filled into a storing tank;
a water-cooling machine is provided and served to cool down the temperature of the gas;
a pump is provided and served to compress the gas;
a water-heating machine is provided and served to raise the temperature of the gas so the gas becomes a supercritical fluid; and
the supercritical fluid is inserted into the extracting tank for extracting the oil.

2. The method of extracting oil of cloth via supercritical fluid as claimed in claim 1, wherein in the step that the cloth to be extracted is provided in the extracting tank, the central portion of the extracting tank is provided with plural slot holes for letting the gas being filled into.

3. The method of extracting oil of cloth via supercritical fluid as claimed in claim 2, wherein in the step that the cloth to be extracted is provided in the extracting tank, the extracted cloth which is in a whole bolt status is reeled at the outer end of the slot holes.

4. The method of extracting oil of cloth via supercritical fluid as claimed in claim 2, wherein in the step that the cloth to be extracted is provided in the extracting tank, the extracted cloth which is in a scattering-pieces status is provided at the outer end of the slot holes.

5. The method of extracting oil of cloth via supercritical fluid as claimed in claim 1, wherein in the step that the gas is filled into the storing tank, the gas is carbon dioxide.

6. The method of extracting oil of cloth via supercritical fluid as claimed in claim 5, wherein the carbon dioxide can be further provided with agents such as MeOH, ETOH, IPA or Acetone but the concentration of the agents is ˜10%.

7. The method of extracting oil of cloth via supercritical fluid as claimed in claim 1, wherein in the step that the gas is filled into the storing tank, the storing tank is further provided with an icy-water sleeve in which gas can be circulated inside for storing the gas.

8. The method of extracting oil of cloth via supercritical fluid as claimed in claim 1, wherein in the step that the water-cooling machine is served to cool down the temperature of the gas, coiled pipes made of carbon dioxide are provided in the water tank of the water-cooling machine for condensing the gas, so the gas is ensured to be the over-liquefied gas before entering the entrance of the pump.

9. The method of extracting oil of cloth via supercritical fluid as claimed in claim 1, wherein in the step that the pump is served to compress the gas, the pump is a diaphragm pump for conveying and compressing the liquefied gas.

10. The method of extracting oil of cloth via supercritical fluid as claimed in claim 1, wherein in the step that the water-heating machine is served to raise the temperature of the gas, coiled gas pipes are provided in the water tank of the water-heating machine, so according to the actual needs the gas can be pressurized for raising the temperature, the temperature is 10˜150° C., the pressure is 10˜1000 bar.

11. The method of extracting oil of cloth via supercritical fluid as claimed in claim 1, wherein the method of extracting oil of cloth via supercritical fluid further includes a step of recycling the supercritical fluid.

12. The method of extracting oil of cloth via supercritical fluid as claimed in claim 1, wherein the method of extracting oil of cloth via supercritical fluid further includes a step of conveying the extracted oil to a separating tank.

13. The method of extracting oil of cloth via supercritical fluid as claimed in claim 1, wherein the method of extracting oil of cloth via supercritical fluid further includes a step of sensing the concentration of the oil via an ultraviolet (UV) sensor; the UV sensor is provided outside of the extracting tank for obtaining the amount of oil containing in the cloth after being extracted.

14. The method of extracting oil of cloth via supercritical fluid as claimed in claim 13, wherein the wavelength of the UV sensor is 254 nm or is a variable wavelength between 190˜700 nm.
